(19) United States
(12) Patent Application Publication
(10) Pub. No.: US 2010/0077320 A1
(43) Pub. Date: Mar. 25, 2010

(54) SGML/XML to HTML conversion system and method for frame-based viewer

(75) Inventors: Marcus A. Lepore, Portsmouth, RI (US); Ralph M. Mariano, Middletown, RI (US); Gregory P. Sabatino, Middletown, RI (US); Brian P. Clayton, Auburn, MA (US); Glen D. Nile, North Attleboro, MA (US)

Correspondence Address: NAVAL UNDERSEA WARFARE CENTER;DIVISION NEWPORT, 1176 HOWELL STREET, CODE 000C, NEWPORT, RI, 02841, US

(73) Assignee: United States Government as Represented by the Secretary of the Navy, Newport, RI (US)

(21) Appl. No.: 12/284,478

(22) Filed: Sep. 19, 2008

(51) Int. Cl. G06F 3/00

(52) U.S. Cl. 715/760

(57) ABSTRACT

A system and method provides conversion of SGML or XML files to HTML files by component conversion techniques. In one embodiment, the system addresses the conversion of an SGML formatted document, with associated graphic and multimedia for viewing in a plurality of frames produced in a web browser, such as with Java or JavaScript. A parser allows for multi-layered HTML documents comprised of dynamically sizing framesets which combines transformed SGML and external components such as graphics multimedia with executable mini-applications that enable external (to the SGML document domain) referencing of add-on interactive features such as local and global search, bookmarks, and annotation. In a preferred embodiment, a Java or JavaScript executable produces a collapsible/expandable table of contents in one of the frames.

### STATEMENT OF GOVERNMENT INTEREST

The invention described herein may be manufactured and used by or for the Government of the United States of America for governmental purposes without the payment of any royalties thereon or therefore.

### BACKGROUND OF THE INVENTION

(1) Field of the Invention

The present invention relates generally to conversion of Standard Generalized Markup Language (SGML) and/or Extensible Markup Language (XML) to Hypertext Markup Language (HTML) and more specifically to enhanced functionality of the resulting conversion.

(2) Description of the Prior Art

Programs to convert SGML and XML to HTML are disclosed in the prior art patents discussed below. As well, the Advanced Interactive Management Technology Center (AIMTC) of the U.S. Navy has designed a software system that provides conversion of SGML and XML to HTML that has resulted in reducing acquisition and life cycle maintenance costs for Fleet training documentation (e.g.,.Technical Manuals, Operational Guidelines, etc.) The system manages Standardized General Mark-Up Language (SGML) and Extensible Mark-up Language (XML) objects and then migrates them to Hypertext Mark-up Language (HTML) readable by the Microsoft Internet Explorer (MSIE) 4.0 Service Release (SR-1 or greater) browser. The originally designed solution has numerous useful features. Database Management of SGML components enables SGML components to be compiled and used in multiple locations. The life cycle maintenance costs are reduced because these SGML components are managed as unique objects in the database where they are singularly stored for alteration and used many times in the final display. Use of a free browser as compared to the traditional use of proprietary (for fee) browsers ultimately reduces distribution costs. The use of approved, generic Navy data formats (SGML, PDF, etc.) enables other Navy activities to reuse the source content.

While present systems are highly useful, the inventors believe it would be desirable to improve the functionality of the resulting converted documents to provide features such as mapping of content classification, multidimensional table of contents, bookmark features, annotation features, local and global search features and/or other highly desirable functionalities in the manner taught hereinafter.

Previous efforts to solve problems related to the above are described by the following patents:

U.S. Pat. No. 5,530,852, issued Jun. 25, 1996, to Meske, Jr. et al., discloses methods for extracting profiles and topics from a first file written in a first markup language and generating files in different markup languages containing the profiles and topics for use in accessing data described by the profiles and topics.

U.S. Pat. No. 5,745,360, issued Apr. 28, 1998, to Leone et al., discloses a methodology used to convert non-HTML softcopy documents to HTML formatted documents based on examination of hypertext link entry points. To resolve these links, the invention interrogates the non-HTML formatted texts for hypertext links, verifies that the links are still valid (determines whether the to-be-linked-to topic, document or reference still exists) and constructs HTML link anchors. After all non-HTML links are resolved (i.e., converted to HTML, verified, and HTML anchors constructed), the entire topic or accessed portion of a requested document or topic text is formatted into HTML text and hypertext links. The most common entry point for beginning the conversion process is the table of contents. This usually provides numerous hypertext entry points to other topics contained in the work. Links can exist at any spot in the work. They are not limited to topic links only.

U.S. Pat. No. 5,819,302, issued Oct. 6, 1998, to J. Nielsen, discloses a method and apparatus for automatically converting documents from a first hypertext format that supports multi-layered backgrounds to a second hypertext format that does not support multi-layered backgrounds, such as HyperText Markup Language (HTML). According to the method, a target file is generated that stores all non-background elements of the document in the second hypertext format. A mechanism that reads the first hypertext format is used to display a current page of the document. A screen dump is made of the displayed page after removing or hiding the non-background elements. This process is repeated for all of the pages of the document. References to the graphics files generated by the screen dumps are embedded in the target file. The references cause the background elements of a page to be displayed behind non-background elements of the page when the document is displayed based upon the target file by a mechanism that reads the second hypertext format.

U.S. Pat. No. 6,009,436, issued Dec. 28, 1999, to Motoyama et al., discloses a method, apparatus, and computer program product for mapping a first structured information format to a second structured information format, which allows a user to interactively define the mapping. This invention operates as a user tool by accepting interactive input from a user of a source input, by processing the input to display the source input in a format for accepting and processing user commands to create or edit a transformation map of source components to target components. Interactive user input is then accepted and processed for selection of an input file to be transformed and selection of a transformation map to be used for the requested transformation. Interactive user input is accepted and processed for selection of individual components of the first structured information format for mapping, and for selection of options for the target components. Exemplary options for the target components are a null value, the source component itself, a single selected target component, or plural selected target components. Interactive user input is accepted for processing to assign attribute values to components of the second structured information format. Exemplary options for the sources of attribute values are attribute values obtained from the source components, system attribute values, no value, attribute values input interactively by the user, and content of element. Interactive user input is then accepted and processed to initiate processing of a transformation of the source input file in the first structured information format to a target output file in the second structured information format.

U.S. Pat. No 6,202,072, issued Mar. 13, 2001, to A. Kuwahara, discloses an apparatus for processing standard generalized markup language document generates a SGML conversion form file correlating a prototype file having a specific form with document type definition by a SGML conversion form generation module, and converts, in a case where a plain text document prepared using the specific form is converted to a SGML document, the prepared plain text document to the SGML document by referring to the SGML conversion form file in a SGML document generation module, while in a case the reverse conversion is executed, the converted SGML document is reversely converted to the plain text document by referring to the SGML conversion form file in a SGML document read-in module.

U.S. Pat. No. 6,393,442, issued May 21, 2002, to Cromarty et al., discloses a method and system for converting a source document into a plurality of documents, each of the plurality of documents having one of a plurality of formats. The method and system comprise providing a document type definition for formatting the source document. The method and system further comprise providing a transform to convert the source document into the plurality of documents. At least one of the plurality of documents has a binary code format. The method and system enable production of the plurality of documents, each representing a version of the source document, such that the versions are consistent with each other.

U.S Publication No. 2002/0122060, published Sep. 5, 2002, to S. O. Markel, discloses a system for generating HTML code for various HTML interfaces such as various set-top boxes using non-technical personnel. The system employs a graphic user interface such as wizard to allow a non-technical user to enter content data to be displayed on the HTML page. The content data is translated by an XML translator into XML code. An XSL parser for a particular HTML interface is used to translate the XML code into HTML code for each particular HTML interface.

US Publication No. 2002/0194227, published Dec. 19, 2002, to Day et al., discloses an adaptive transformation and User Interface system that enables transformation of a file or document (e.g., an SGML, XML, HTML or other multimedia file or document) from one format to another format. The transformation supports error correction, filtering and collation of elements of a source document for output and is performed in response to control information comprising transformation parameters. The system transforms a document encoded in a language including presentation style determination attributes from a first format to a different second format. The system includes a source of transformation parameters determining a desired presentation style and content structure as well as an input document processor. The input document processor transforms a received input document in a first format by parsing the input document and collating elements of the input document into a hierarchically ordered structure representing an intermediate document structure. The system employs a transformation processor for transforming the intermediate document structure into an output document with the desired presentation style of a second format in response to the transformation parameters.

The above listed patents do not provide for expanded functionality of the converted document such as mapping content classification, multidimensional table of contents, bookmark features, annotation features, local and global search features and other highly desirable functionality as taught herein. Consequently, those skilled in the art will appreciate the present invention that addresses the above and other problems.

### SUMMARY OF THE INVENTION

An object of the present invention is an improved method of taking Standardized General Mark-up Language (SGML) data and its logical equivalent Extensible Mark-up Language(XML), formatted in compliance with predetermined rules (this can be style guidance such as the NAVSEA02 Rev D DTD) and converting it into HyperText Mark-Up Language (HTML) suitable for viewing using the Microsoft Internet Explorer (MSIE) 4.01 SR1 or greater web browser.

These and other objects, features, and advantages of the present invention will become apparent from the drawings, the descriptions given herein, and the appended claims. However, it will be understood that above listed objects and advantages of the invention are intended only as an aid in understanding aspects of the invention, are not intended to limit the invention in any way, and do not form a comprehensive list of objects, features, and advantages.

Accordingly, the present invention provides a method for converting SGML or XML source documents to HTML for viewing the SGML source documents in a web browser which method may comprise one or more steps such as, for instance, converting each tag, entity, and attribute of a source document to HTML output files such that each chapter, index, appendix, and glossary are divided into separate HTML output files, creating a plurality of browser frames for viewing the HTML output files comprising at least a content web browser frame, a local navigation web browser frame, and a global navigation web browser frame. Other steps may comprise providing that the content frame comprised of the HTML output files combined with graphic images from the source document for the content web browser frame, and/or generating a table of contents for the local navigation frame, and/or providing that the content frame is selectively scrollable whereby when the content frame is scrolled then the table of contents is also scrolled to include a portion of the table of contents related to the HTML output files and graphic images displayed in the content frame. The method may further comprise utilizing a Java or JavaScript executable for the steps of converting, creating, and generating.

The step of generating the table of contents may further comprise mapping chapter, section, paragraphs, subparagraphs, figures, foldouts, tables, multimedia components from the source document to thereby provide an expandable/collapsible table of contents. The method may further comprise creating a classification browser frame based on an attribute of the source document relating to a classification of the source document, e.g., “Top Secret”.

The method may further comprise parsing the source document and stripping out structure elements to thereby generate a plain text file and/or producing a local query interface to interactively query for matches with the plain text file to provide local searching capability. To provide global searching, the method may further comprise parsing a plurality of documents related to the source document and stripping out the structures elements to generate one or more plain text files and/or producing a global query interface to interactively query for matches with the one or more plain text files to provide global search capability.

Other steps may comprise mapping an attribute defined in the source document to a bookmark icon displayed in the web browser and/or providing a Java or JavaScript executable application code that when enabled by selection of the annotation icon allows a user to interactively query for bookmarks and/or mapping an attribute defined in the source document to an annotation icon displayed in the web browser and/or providing a Java or JavaScript executable application code that when enabled by selection of the annotation icon allows a user to interactively produce and retrieve annotations.

The method may further comprise providing HTML hyperlinks for all SGML tags and attributes may comprise xref, xerfid, glossary, and term to provide glossary, term, and definition links viewable in the web browser.

Accordingly a software system is also provided for conversion of SGML or XML source documents to HTML such that a user can view the SGML or XML source documents in a web browser. The software system may comprise one or more elements such as, for instance, an executable code operable to convert each tag, entity, and attribute of a source document to HTML output files such that each chapter, index, appendix, and glossary is divided into separate of the HTML output file. The executable code is preferably operable for creating a plurality of browser frames for viewing the HTML output files may comprise at least a content frame, a local navigation frame, and a global navigation frame. The content frame is preferably comprised of the HTML output files combined with graphic images from the source document for the content frame. The content frame is preferably navigable such as with an associated scroll tag. The local navigation frame is preferably generated by the executable code to provide a table of contents that is navigable with an associated scroll tag. In one preferred embodiment, the executable code comprises Java or JavaScript.

The software system executable code is preferably operable for generating the table of contents by mapping chapter, section, paragraphs, subparagraphs, figures, foldouts, tables, multimedia components from the source document to thereby provide an expandable/collapsible table of contents.

The software system executable code is, in one embodiment, operable for creating a classification browser frame based on an attribute of the source document relating to a classification of the source document.

The system may further comprise a parser operable for parsing the source document and stripping out structure elements to thereby generate a plain text file and/or a local query interface to interactively query for matches with the plain text file to thereby provide local searching capability. The system may further comprise a parser for parsing a plurality of documents related to the source document and stripping out the structures elements to generate one or more plain text files and/or a global query interface to interactively query for matches with the one or more plain text files to provide global search capability.

In a preferred embodiment, the system is operable for mapping an attribute defined in the source document to a bookmark icon displayed in the web browser and providing a Java or JavaScript executable application code that when enabled by selection of the annotation icon allows a user to interactively query for bookmarks. Additionally, the system is operable for mapping an attribute defined in the source document to an annotation icon displayed in the web browser and/or providing a Java or JavaScript executable application code that when enabled by selection of the annotation icon allows a user to interactively produce and retrieve annotations. Preferably, the system executable code is operable to provide Glossary, term, and definition links viewable in the web browser.

### BRIEF DESCRIPTION OF THE DRAWINGS

A more complete understanding of the invention and many of the attendant advantages thereto will be readily appreciated as the same becomes better understood by reference to the following detailed description when considered in conjunction with the accompanying drawing, wherein like reference numerals refer to like parts and wherein:

FIG. 1 is a table which shows an SGML to HTML tag map for an original Java filter in accord with the invention;

FIG. 2 is a table which shows an SGML/XML attribute map for use in accord with the present invention;

FIG. 3 is a web browser view of sample SGML/XML tags and attributes such as those identified in FIG. 1 and FIG. 2 in accord with the present invention; and

FIG. 4 is a web browser view of a sample HTML display produced from SGML/XML tags and attributes identified in FIG. 1 and FIG. 2 in accord with the present invention.

### DETAILED DESCRIPTION OF THE INVENTION

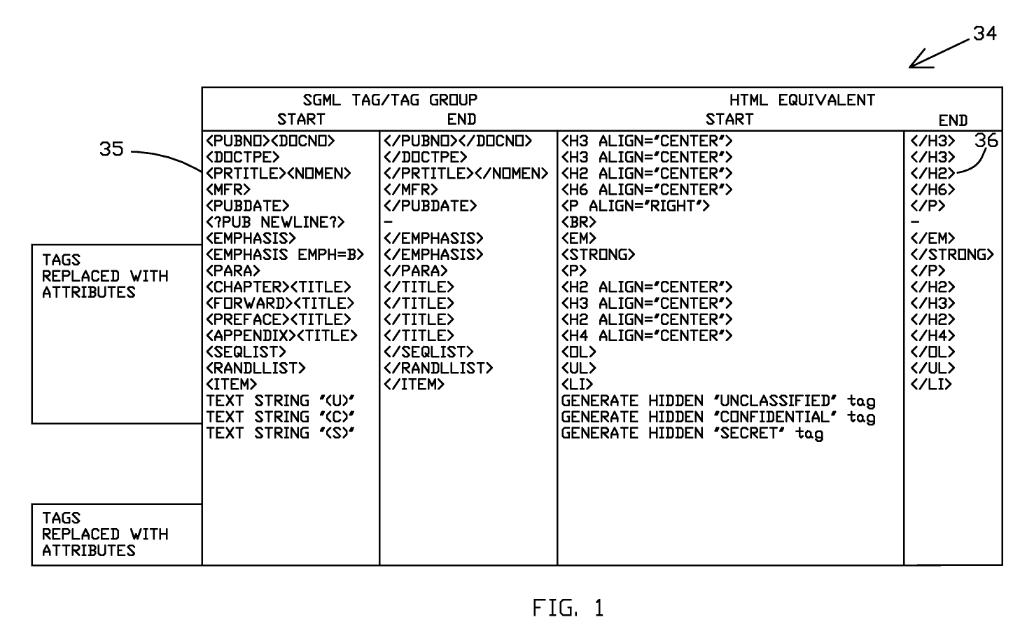

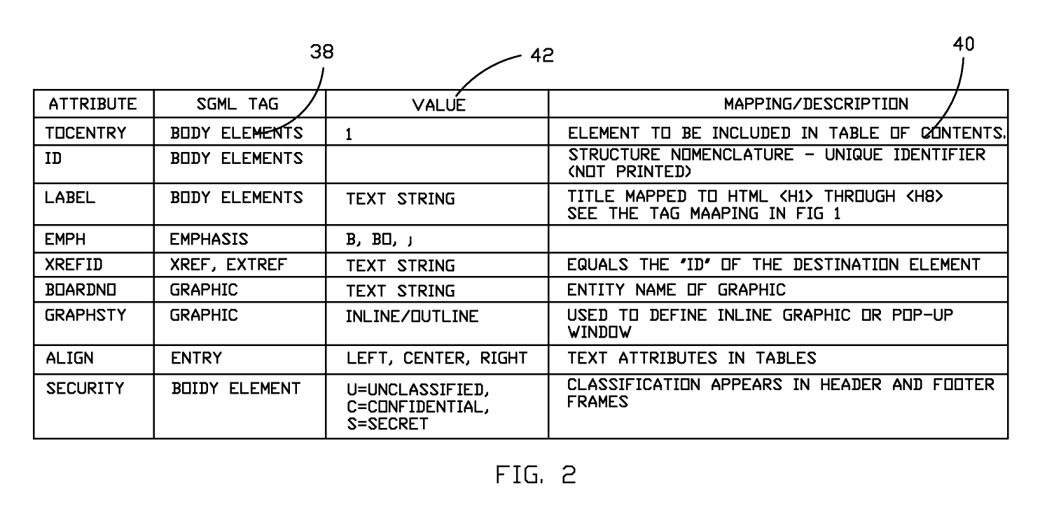

The present invention provides for a SGML/XML to HTML Java and JavaScript conversion script which will be integrated into the presently existing U.S. Navy technical document management system to produce HTML files. SGML components may be maintained and/or authored utilizing the Arbortext Adept series, stored in the Chrystal Astoria component level Document Manager, and then exported to the file system as XML. The SGML/XML to HTML Java and Java Scrip conversion script in accord with the present invention convert the XML documents into the HTML format in accord with examples shown in FIG. 1 and FIG. 2 which disclose how SGML attributes and tags are mapped to an HTML equivalent.

In a preferred embodiment, the presently improved system utilizes open architecture, non-proprietary systems and method (Java and JavaScript) which enables entire system to be migrated from developer to developer without having to purchase proprietary systems, re-train developers, or re-author the source content to fit the new developers' inherent system.

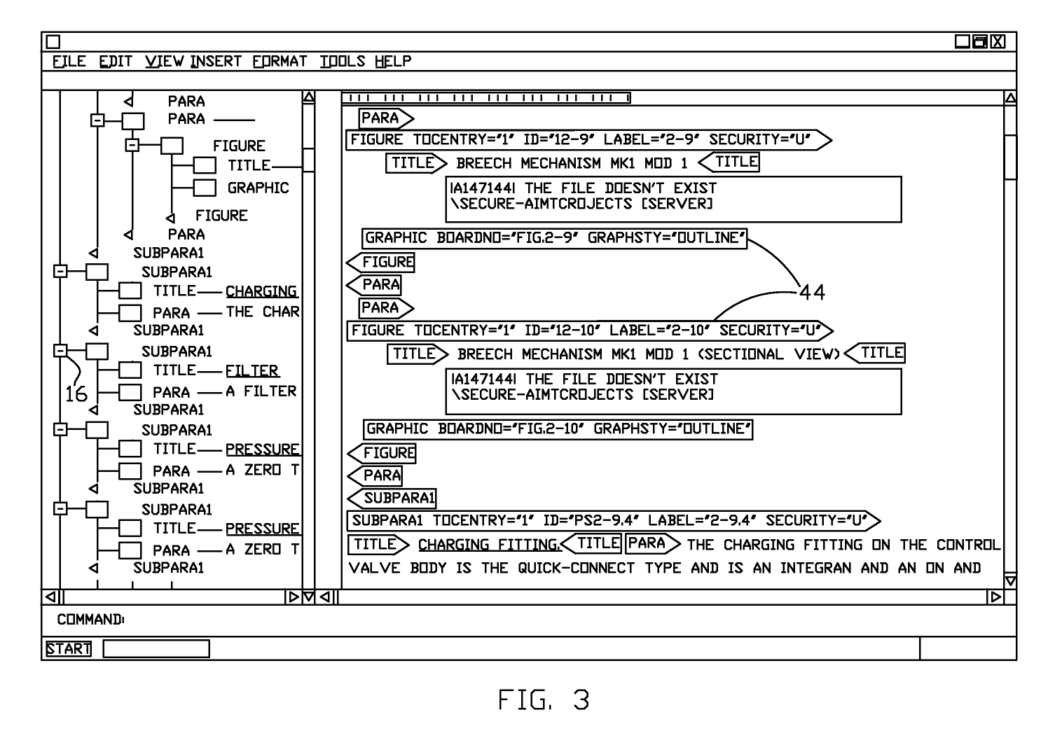

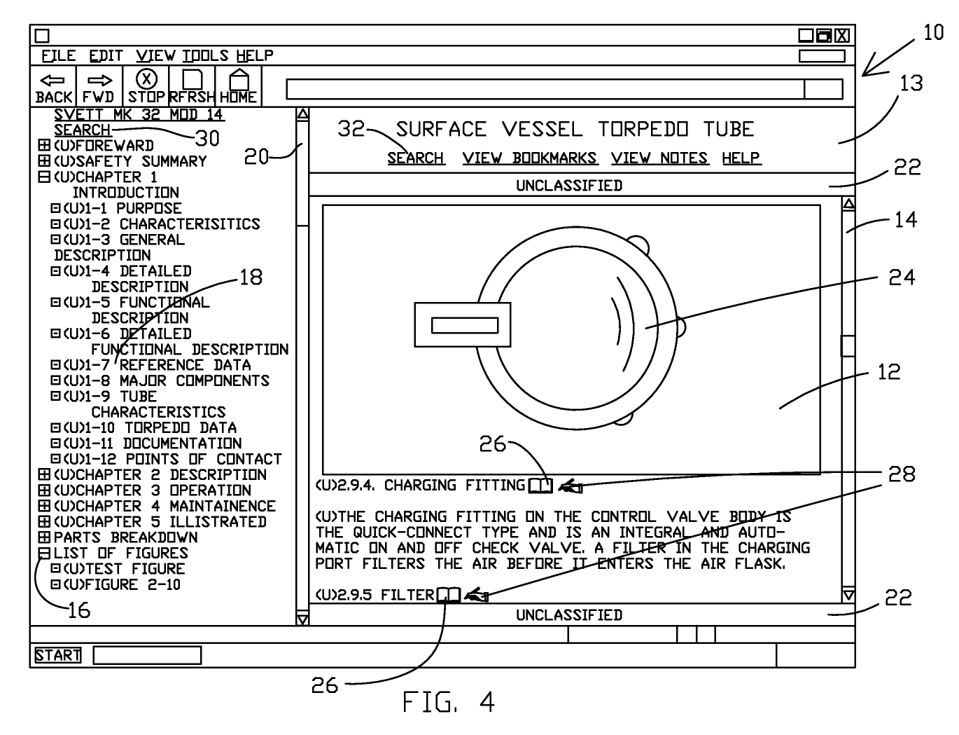

The SGML/XML to HTML Component Conversion Method combines open architecture, non-proprietary Commercial Off The Shelf (COTS) authoring and storage products with developmental items. Some aspects of a preferred embodiment the system include an ODBC compliant object oriented database and the ultimate format of the baseline technical documentation data in SGML and XML. The display is provided using one of the common, freely distributable browsers (i.e., HTML output). In the resulting conversion, the functionality of Interactive Electronic Technical Manuals (bookmarks, annotation, full text search) is supported. Various features include a frames based display, classification banners, and an expandable Table of Contents (TOC) with word wrap (see FIG. 3 and FIG. 4).

In one embodiment, the method comprised of an Arbortext Adept Series is used to edit and publish the SMGL/XML components but any SGML editor will suffice. A Xerox Document Management groups Chrystal SGML component database management product may be used but any ODBC compliant object oriented database capable of handling SGML components will suffice. Various Java and JavaScript authoring tools may be utilized. Baseline commercial utilities may include a parsing engine and XML library.

The conversion process initiates by defining an overall “Class” variable that determines the conversion class, such as for any SGML DTD. The (DTD) Document Type Definitions provide definitions for each tag, entity, and attribute for the conversion class. In one case, the class may define the mappings to HTML as methods that are called from an external XML parsing engine when the document starts, ends, and then every time any element, comment or processing instructions are encountered in the source document or fragment. Possible examples of such definitions for a class of SGML tags are shown in FIG. 1 and FIG. 2. As indicated in FIG. 1 and FIG. 2, the Java/JavaScript executable converts each method (tag, entity, and attribute) to HTML in accordance with the HTML 3.0. DTD. In one embodiment, the SGML/XML tags, entities and attributes are formatted in accordance with the NAVSEA02 DTD. The output files are then combined with the graphic images, which may be separate .pdf files, in the appropriate folder structure to yield the final web viewable electronic document.

The conversion application checks attribute values as indicated in FIG. 2 of appropriate elements during the conversion process. Each chapter, index, appendix, and glossary is divided into a separate HTML file during the conversion process. The conversion process creates four types of frames: content frame 12, global navigation frame 13, local navigation frame 16, and classification frame 22.

Content frame 12 is preferably located at the center right of browser display 10. The content frame displays the content of a specified book, i.e., a converted HTML document. Vertical scroll bar 14 may be utilized to scroll up and down for navigating this frame.

Local navigation frame 16 is located to the left of the content frame. Local navigation frame 16 displays Table of Content (TOC) 18 of the section currently displayed in content frame 12. As the user moves within content frame 12, the appropriate TOC displays in local navigation frame 16. Vertical scroll bar 20 may be utilized to scroll up and down to navigate this frame. Preferably, TOC 18 is created by using collapsible tree view which is accomplished using either JavaScript or a Java applet.

Global navigation frame 13 is shown at the top of the browser display. The currently open file is preferably displayed prominently in the frame 13. This frame 13 provides links such as those shown for SEARCH, VIEW BOOKMARKS, VIEW NOTES, and HELP that are available and applicable to all sections, not limited to the section currently open in the content frame.

Classification frame 22 is located at the top and bottom of the browser display 10. Classification frame 22 displays the highest classification of the content current HTML document being displayed in content frame. All possible classifications in descending order are: Secret (S), Confidential (C), and Unclassified (U). If desired, classification frame or another frame may be utilized to display on the highest classification of what is currently being displayed on the screen in classification frame.

Graphics 24 can appear inline within content frame 12 or as a separate pop-up window of the application spawning the graphic, e.g., Adobe acrobat, Internet Explorer, and the like, and may contain a separate classification banner which is generated from the security attribute as indicated in FIG. 2.

Bookmarks, annotations, and local and global search functions appear in separate Internet Explorer pop-up windows. Bookmarks may be generated by selecting the bookmark icon 26 which appears in the HTML after each document section. The mechanisms for generating bookmark icon 26 comprise providing a unique SGML tag after each “para0”0 and “subpara1” which the filter migrates to a hyperlinked icon. When the user wants to create a bookmark, he simply selects bookmark icon 26 and a bookmark is generated. When the user wants to retrieve a bookmark, he selects the “bookmark” hyperlink in the local or global navigation or table of contents frame 16 which generates a new browser instance pop-up window that displays all the bookmarks generated during the user defined session that the user can then select to display the bookmarked content in the same window.

Annotations are generated by selecting annotation icon 28 which appears in the HTML after each document section. The mechanisms for generating annotation icon 28 comprise utilizing a unique SGML tag after each “para0” and “subpara1” which the filter migrates to a hyperlinked icon. When the user wants to create an annotation, he simply selects annotation icon 28 and an annotation is generated. When the user wants to retrieve an annotation, he selects the “annotation” hyperlink in the local or global navigation or table of contents frame 16 which generates a new browser instance pop-up window that displays all the annotations generated during the user defined session and also the content of the annotation. The user can then select the text that the note is anchored to which displays the full context against which the note is generated in the same pop-up window.

Search (both local and global) is initiated by selecting search hyperlink 30 or 32 in the respective local or global navigation frame, which generates a pop-up window that prompts the user to enter the string to be searched. The search engine then combs either a local (current document) or global (all documents in the collection) text (.txt) files which contains ASCII text characters for all content, and then displays the results (with hyperlinked text) in a new browser instance pop-up window.

It is to be noted that each of the pop-up windows (for bookmarks, annotations, and search) preferably contains a classification banner frame (above and below the destination data) generated from the “Security” attribute nested in the SGML baseline.

The current method preferably translates “Warning”, “Caution”, and “Note” SGML tags to HTML specific formatted text complete with the appropriate Icons. The present invention preferably provides Hyperlinks (HTML) for all SGML tags and attributes (“xref”, “xerfid”, “Glossary”, and “term”) for intra and inter document links, Glossary, and term and definition links.

A combined Java and JavaScript software program in accord with the present invention translates SGML/XML tags, entities, and attributes form the source document to HTML standard (WWW HTML 3.0) tag sets that are meaningful and viewable in at least the MSIE 4.01 Service Release (SR) 1 web browser as indicated in FIG. 1 and FIG. 2.

In FIG. 1, Tag map 34 shows SGML tags 35 which are converted into HTML viewable tags 36 with a Java filter. In FIG. 2, SGML/XML attribute map shows how the elements are to be mapped into HTML. For instance, body elements 38, which may comprise paragraph tags (para0, subpara1), figures, tables, etc., are mapped into a Java/JavaScript produced table of contents as indicated at 40. As noted above, the conversion application checks attribute values, such as values 42 of appropriate elements during the conversion process. FIG. 3 shows the tags 44 and attributes identified in FIG. 1 and FIG. 2 as applied to the new HTML browser viewer. Each chapter, index, appendix, and glossary is divided into a separate HTML file during the conversion process. Thus, in a preferred embodiment as noted above, the conversion process creates four types of frames: content frame 12, global navigation frame 13, local navigation frame 16, and classification frame 22.

The electronic document users of the converted HTML documents allows users to view their documents in a uniquely presented frame based HTML environment 10 with full functioning reference links including Glossary, terms, and definition references. As well, the user may search all text in a local or global mode. It is also possible for the user to link to/from the results and to create annotations and bookmarks in the HTML document. The process/product also auto-generates TOC (table of contents) structure data preferably using a combined Java/JavaScript runtime executable.

Thus, the present invention provides uniquely archived features of bookmarks, annotations, and full text searches from within web browser interface 10 but maintained in the SGML/XML base line. The baseline data is formatted in a hierarchical, object-oriented database, which allows for the reuse of common data. This is a great cost benefit/savings which enables developers to change source content one time in the baseline even though it may appear in numerous locations. The content may be used with other training sources. The source content of SGML components, which can be reused as source, and the final output of HTML files, can be easily re-used with other training systems as stand-alone chunks as long as a compatible web browser is available.

Alternative embodiments may comprise using extensible Style Language (XSL) or cascading style sheets along with Microsoft's MSXML DLL. Another approach employs a customized version of the conversion script authored in a programming language other than Java, e.g., C++, VB, and the like.

There are many documents authored in SGML in other industries (e.g., law, publishing) for which there are no free viewers for SGML. However, the present method formats the data to be viewable in the Microsoft Internet Explorer 4.0 or greater browser configuration which for all intents and purposes is free complete with additional functionality of searching all content in standalone (not web server) mode and allows for bookmarking and annotating all data in the collections (even to a specific location within an HTML file.

In summary, the present invention provides a mapping for Military Document Type Definition (DTD) specific components, which address unique attributes and elements not provided by commercial DTDs. Some (but not all) of the elements and attributes incumbent in the NAVSEA02 DTD include content classification (unclassified—FOUO, Confidential, Secret, Top Secret). In this case, this attribute is parsed and represented by a dynamic frameset component that maps to the highest classification of the active HTML, graphic, or multimedia file or document.

The present invention provides mapping chapter, section, para, subpara, Figure, foldout, table, multimedia components to multi-dimensional (expandable/collapsible) Table of Contents (TOC) 18 integrated frameset.

The present invention provides a bookmark feature that dynamically anchors a return feature to any translated SGML/XML component in the HTML. The process requires that a unique SGML component and attribute be defined in the source data that is mapped to icon classes, and executable application code (JavaScript or Java for example) that, when enabled, execute the bookmark write and retrieve features, via separate code execution when activated. Additionally, the method integrates the executable code that when activated, spawns the query interface which allows the use to interactively query the subject domain for populated bookmarks.

An annotation feature dynamically anchors a return and user defined, interactive note feature to any translated SGML/XML component in the HTML. The process requires that a unique SGML component and attribute be defined in the source data that is mapped to icon classes, and executable application code (JavaScript or Java for example) that, when enabled, executes the annotation and note append, write, and retrieve features, via separate code execution. Additionally, the method integrates the executable code that when activated, spawns the query interface which allows the use to interactively query the subject domain for populated annotations.

The present invention provides for local and global full text search. The SGML plain text file is parsed and the structure elements are stripped out to generate a plain text file. The local feature interrogates a single document (SGML source file) domain and the global search interrogates a multi-volume (configurable number of SGML source files) domain, parses, and collates into separate document volumes and displays associated meta data components housed in the SGML source. Additionally, the method integrates the executable code that when activated, spawns the query interface which allows the user to interactively query the subject domain for matches and which then dynamically escalates to the results interface.

The invention provides for dynamic handling of reverse links from the graphics to textural information. The method converts and dynamically manages location and specific vector location hyperlinks. The method dynamically manages the HTML representation by combining style sheets and application code to render a configurable multi-frame format. The method dynamically configures the translation from the source file information which includes dynamically managing the structure components and the scope of the items to consider in an individual or automated sequence of application runs.

Thus, the present invention provides for conversion of an SGML formatted document, with associated graphic, multimedia to configurable HTML stances. The parser allows for multi-layered HTML documents comprised of dynamically sizing framesets which combines transformed SGML and external components such as graphics, multimedia, and executable mini-applications that enable external (to the SGML document domain) referencing any add-on interactive features such as local and global search, bookmarks, and annotations. The parser translates all SGML structure specific attributes to unique HTML elements.

It will be understood that many additional changes in the details, materials, steps and arrangement of parts, which have been herein described and illustrated in order to explain the nature of the invention, may be made by those skilled in the art within the principle and scope of the invention as expressed in the appended claims.

What is claimed is:

1. A method for converting source documents in a predefined markup language to HTML for viewing the source documents in a web browser, comprising:
converting each tag, entity, and attribute of the source document to HTML output files such that each chapter, index, appendix, and glossary of the source document are divided into separate HTML output files;
creating a plurality of browser frames for viewing said HTML output files comprising at least a content web browser frame, and a local navigation web browser frame;
providing that said content web browser frame is comprised of said HTML output files combined with graphic images from said source document for said content web browser frame;
generating a table of contents for said local navigation web browser frame; and
providing that said content web browser frame is selectively scrollable whereby when said content web browser frame is scrolled then said table of contents in said local navigation web browser frame is also scrolled to include a portion of said table of contents related to said HTML output files and graphic images displayed in said content web browser frame.

2. The method of claim 1 wherein said step of creating a plurality of browser frames further comprises creating a global navigation web browser frame for navigating previously stored HTML output files and said HTML output files displayed in said content web browser frame.

3. The method of claim 1 wherein said step of generating said table of contents further comprises mapping chapter, section, paragraphs, subparagraphs, figures, foldouts, tables, multimedia components from said source document to thereby provide an expandable/collapsible table of contents in said local navigation web browser frame.

4. The method of claim 1 further comprising creating a classification web browser frame based on an attribute of said source document relating to a classification of said source document.

5. The method of claim 1 further comprising:
parsing said source document and stripping out structure elements to thereby generate a plain text file; and
producing a local query interface to interactively query for matches with said plain text file to provide local searching capability.

6. The method of claim 5 further comprising:
parsing a plurality of documents related to said source document and stripping out said structures elements to generate at least one plain text file; and
producing a global query interface to interactively query for matches with said at least one plain text file to provide global search capability.

7. The method of claim 1 further comprising:
mapping an attribute defined in said source document to a bookmark icon displayed in said web browser; and
providing a Java or JavaScript executable application code that when enabled by selection of said annotation icon allows a user to interactively query for bookmarks.

8. The method of claim 1 further comprising:
mapping an attribute defined in said source document to an annotation icon displayed in said web browser; and
providing a Java or JavaScript executable application code that when enabled by selection of said annotation icon allows a user to interactively produce and retrieve annotations.

9. The method of claim 1 further comprising providing HTML Hyperlinks for all source file tags and attributes comprising xref, xerfid, glossary, and term to provide glossary, term, and definition links viewable in said web browser.

10. A software system for conversion of source documents in a predefined markup language to HTML such that a user can view said source documents in a web browser, comprising:
an executable code operable to convert each tag, entity, and attribute of a source document to HTML output files such that each chapter, index, appendix, and glossary is divided into separate HTML output files, said executable code being operable for creating a plurality of browser frames for viewing said HTML output files comprising at least a content frame, a local navigation frame, and a global navigation frame;
said content frame being navigable with an associated scroll tag and being comprised of said HTML output files combined with graphic images from said source document for said content frame;
said local navigation frame being navigable with an associated scroll tag and being auto-generated by said executable code to provide a table of contents; and
said global navigation frame being navigable with an associated scroll tag and being auto-generated by said executable code to allow navigation of previously stored HTML files and said HTML output files in said content frame.

11. The system of claim 1 wherein said executable code comprises Java or JavaScript.

12. The system of claim 1 wherein said executable code is operable for auto-generating said table of contents by mapping chapter, section, paragraphs, subparagraphs, figures, foldouts, tables, multimedia components from said source document to thereby provide an expandable/collapsible table of contents.

13. The system of claim 1 wherein said executable code is operable for creating a classification browser frame based on an attribute of said source document relating to a classification of said source document.

14. The system of claim 1 further comprising:
a parser operable for parsing said source document and stripping out structure elements to thereby generate a plain text file; and
a local query interface to interactively query for matches with said plain text file to thereby provide local searching capability.

15. The method of claim 1 further comprising:
a parser for parsing a plurality of documents related to said source document and stripping out said structures elements to generate one or more plain text files:
a global query interface to interactively query for matches with said one or more plain text files to provide global search capability.

16. The system of claim 1 wherein said executable code is operable for mapping an attribute defined in said source document to a bookmark icon displayed in said web browser and providing a Java or JavaScript executable application code that when enabled by selection of said annotation icon allows a user to interactively query for bookmarks.

17. The system of claim 1 wherein said executable code is operable for mapping an attribute defined in said source document to an annotation icon displayed in said web browser and when enabled by selection of said annotation icon allows a user to, interactively produce and retrieve annotations.

18. The system of claim 1 further wherein said executable code is operable to provide glossary, term, and definition links viewable in said web browser.
